(19) United States
(12) Patent Application Publication
(10) Pub. No.: US 2007/0188311 A1
(43) Pub. Date: Aug. 16, 2007

(54) Burglarproof device for bicycle

(76) Inventor: Keon Soo Shin, Goyang-si (KR)

Correspondence Address: IPLA P.A., 3580 WILSHIRE BLVD., 17TH FLOOR, LOS ANGELES, CA, 90010, US

(21) Appl. No.: 10/598,659

(22) PCT Filed: Mar. 8, 2005
(86) PCT No.: PCT/KR05/00643

§ 371 Date: Sep. 7, 2006

(30) Foreign Application Priority Data
Mar. 9, 2004 (KR) 10-2004-0015695

(51) Int. Cl. B62J 6/00

(52) U.S. Cl. 340/432

(57) ABSTRACT

An burglarproof device for a bicycle includes a locking means for safely storing a bicycle, an installation means for easily installing the locking on the frame of the bicycle, and an alarming means for generating an alarm to the exterior for proper action when an unauthorized person attempts to steal the bicycle. The bicycle owner can fix his bicycle to an object and lock it in a more convenient and easier manner. The locking means includes a body, a wire drum, a wire, a clamp jig, a wiring, a tension mechanism, and a solenoid unit. The installation means includes a bracket, a latch, a band, and a clasp. The alarming means includes a disconnection detection loop, a switch, a controller, and an alarm.

### TECHNICAL FIELD

The present invention relates to an burglarproof device for a bicycle, and more particularly to an burglarproof device for a bicycle adapted to alarm nearby people, when an unauthorized person arbitrarily attempts to cut or dissemble a locking means to steal a bicycle fastened by the locking means, through an alarming means provided on the body of a keying device installed on the bicycle and transmit an alarm signal to a remote control alarm to alarm the bicycle owner carrying the remote control alarm through another alarming means provided on the remote control alarm so that, even when the bicycle owner is in a remote area, he can be instantly informed of the theft attempt and quickly respond.

### BACKGROUND ART

In general, a bicycle is a light and simple device propelled by pushing pedals with the operator's both feet to rotate a wheel through a chain. Bicycles are widely used in a hobby, such as hiking, and are considered as a good means to provide modern people, who suffer from insufficient exercise, with a suitable amount of exercise. Therefore, most homes are furnished with at least one bicycle. Bicycles are seldom stored indoors, but usually outdoors. If a bicycle owner lives in a large private house, he might have little difficulty in storing his bicycle safely. In the case of a person living in a public building such as an apartment, however, he cannot avoid storing his bicycle in an open space accessible to anyone. If the bicycle is stored without any safety means, it is vulnerable to theft.

When a bicycle is stored, therefore, an burglarproof device is generally used to prevent it from being stolen. Various types of burglarproof devices are available, including an apparatus composed of a chain and a lock. A person living in an apartment, for example, may place his bicycle near banisters and bind a part of the bicycle, such as spokes, and the banisters with a chain. A lock is then fastened while overlapping both ends of the chain to safely store the bicycle. When the bicycle is to be used, the lock is unfastened with a key to release the bicycle. The chain is then wound around the banisters only and the lock is again fastened while overlapping both ends of the chain.

### DISCLOSURE OF INVENTION

### Technical Problem

Although various burglarproof devices have been developed and used, including the simplest type of one as mentioned above, they are actually inconvenient in several aspects and are not very effective in preventing bicycles from being stolen. This is because, when a bicycle owner stores his bicycle or uses the stored one, he must move near the front or rear wheel of the bicycle and bend or squat down to wind a chain and fasten or unfasten a lock, which is a very inconvenient and tedious procedure. As a result, most bicycle owners avoid locking their bicycles, which then become vulnerable to theft.

Even when a bicycle owner consistently and carefully uses an burglarproof device composed of a chain and a lock, in spite of a tedious procedure as mentioned above, the chain can be easily cut with a cutter and the bicycle is still vulnerable to theft. A recently developed and used burglarproof device attached to the frame of a bicycle to alleviate inconvenience, however, still has a problem in that its part corresponding to the chain of conventional burglarproof devices can be easily cut and, particularly during running, the locking device may be erroneously actuated by the vibration of the bicycle and can cause an accident.

### TECHNICAL SOLUTION

Therefore, the present invention has been made in view of the above-mentioned problems, and it is an object of the present invention to provide an burglarproof device for a bicycle adapted to enable a bicycle owner to fasten his bicycle to a fixed facility in an easy and convenient manner and alarm nearby people, when an unauthorized person attempts to steal the bicycle, as well as the bicycle owner through a remote control alarm carried by him so that, even when he is remote from the bicycle, he can be instantly informed of the theft attempt and quickly respond.

According to an aspect of the present invention, there is provided an burglarproof device for a bicycle including a locking means for fixing a bicycle to an object to prevent it from being stolen; an installation means for installing the locking means on the frame of the bicycle; and an alarming means for displaying the locking status of the locking means to the exterior, wherein the locking means includes a body formed by coupling upper and lower covers to each other with a fastening member; a wire drum installed at the center of the body and adapted to rotate by means of a wire drum shaft coupled through a hollow; a wire wound around the wire drum; a clamp jig having a fixing groove formed along a lateral surface of a front head portion thereof with the wire inserted into and coupled to the rear surface thereof; a first wiring installed on a side of the outer surface of the upper cover, the front surface of the first wiring being open and the rear surface thereof having a through-hole dimensioned to allow the wire to pass through but not the clamp jig; a second wiring formed on the other side of the outer surface of the upper cover, both front and rear surfaces of the second wiring being open to allow the clamp jig to pass through; a tension mechanism installed inside the body to contact the front head portion of the clamp jig, which has passed through the second wiring, horizontally and apply an elastic force to the clamp jig; and a solenoid unit having a fixing member formed on the upper side thereof, which is adapted to travel vertically under the action of an electronic solenoid to be inserted into or spaced from the fixing groove of the clamp jig.

The burglarproof device for a bicycle according to the present invention enables a bicycle owner to easily and conveniently fasten his bicycle to an object fixed to the ground and store it without any separate lock or chain and instantly generates an alarm to the exterior for proper action when an unauthorized person attempts to steal the bicycle.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a lateral sectional view showing an burglarproof device for a bicycle according to the present invention;

FIG. 2 is a top view showing an burglarproof device for a bicycle according to the present invention;

FIG. 3 is a front view showing an burglarproof device for a bicycle according to the present invention;

FIG. 4 shows a band used in an installation means constituting an burglarproof device for a bicycle according to the present invention;

FIG. 5 shows in brief the construction of an alarming means constituting an burglarproof device for a bicycle according to the present invention;

FIG. 6 is a detailed circuit diagram of the alarming means shown in FIG. 5; and

FIG. 7 is a detailed circuit diagram of a remote control alarm.

### BEST MODE FOR CARRYING OUT THE INVENTION

Reference will now be made in detail to the preferred embodiments of the present invention.

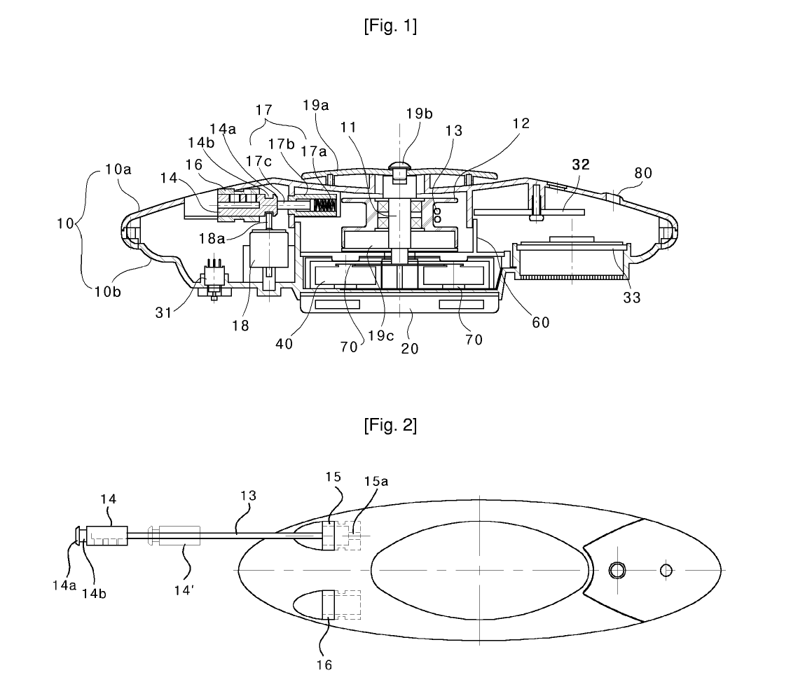

An burglarproof device for a bicycle according to the present invention includes a locking means for safely storing a bicycle, an installation means for simply installing the locking means on the frame of a bicycle, and an alarming means for generating an alarm to the exterior for proper action when an unauthorized person attempts to steal the bicycle. The locking means will now be described with reference to FIGS. 1 and 2.

FIGS. 1 and 2 are a lateral sectional view and a top view showing an burglarproof device for a bicycle according to the present invention, respectively.

Referring to the drawings, the locking means includes a body 10, a wire drum 12, a wire 13, a clamp jig 14, wirings 15 and 16, a tension mechanism 17, and a solenoid unit 18.

The body 10 is formed by separately molding upper and lower covers 10a and 10b and coupling them to each other with a fastening member. The body 10 has a space defined therein to accommodate the wire drum 12 and the solenoid unit 18. The body 10 has a separate wire drum cover 19a installed on the upper surface of the upper cover 10a by a pin 19b and a screw 19c, as well as a bracket 20 formed on the lower surface of the lower cover 10b, which constitutes the installation means. The bracket 20 is made of a metallic material so that, when an impact is applied to the body 10 for stripping, it does not easily fracture. The bracket 20 is insert-molded on the bottom surface of the lower cover 10b to be integral with the latter.

The wire drum 12 is installed at the center of the body 10 and has the wire 13 wound around it. The wire drum 12 has a wire drum shaft 11 coupled to inner hollow thereof and the wire 13 is coupled to the clamp jig 14 so that, when the operator pulls the clamp jig 14, the wire drum shaft 14 rotates and the wire 13 is drawn out of the body 10. The wire drum shaft 11 has a separate main spring 19d connected thereto and for actuation so that, when the operator ceases to pull the clamp jig 14 from the exterior, the wire drum 12 rotates in the opposite direction and the wire 13 returns to the initial state.

As shown in FIG. 2, the upper cover 10a has first and second wirings 15 and 16 installed on the outer surface thereof. The front surface of the first wiring 15 is open and the rear surface thereof has a through-hole 15a formed thereon so that the clamp jig 14 can be inserted into the front surface and an end of the wire 13 wound around the wire drum 12 inside the body 10 can pass through the through-hole 15a to be coupled to the clamp jig 14. The through-hole 15a is dimensioned to allow the wire 13 to pass through, but not the clamp jig 14, so that the clamp jig 14 remains seated on the interior of the first wiring 15. Both front and rear surfaces of the second wiring 16 are open so that the clamp jig 14 can pass through. The rear surface of the second wiring 16 leads into the body 10 so that the front head portion 14a of the clamp jig 14, which has passed through the second wiring 16, can interact with the tension mechanism 17 and the solenoid unit 18 inside the body 10.

The clamp jig 14 has a fixing groove 14b formed along the lateral surface of the front head portion 14a. The tension mechanism 17 includes a support unit 17b having a spring 17a therein and a contact rod 17c inserted into a hole (not shown) formed on the front surface of the support unit 17b to receive an elastic force from the spring 17a and directly contact the head portion 14a of the clamp jig 14 horizontally. The solenoid unit 18 has a fixing member 18a adapted to travel vertically under action of an electronic solenoid.

The locking means configured as above is installed on a bicycle by various installation means for use. A procedure for storing a bicycle using the locking means will now be described in detail.

An operator places his bicycle near an object for fixing the bicycle, such as banisters of a staircase in an apartment, as much as possible. The clamp jig 14 seated inside the first wiring 15 is pulled to draw the wire 13 wound around the wire drum 12.

The wire 13 is wound around the object, such as banisters, and a part of the bicycle, such as a wheel or a frame, and the clamp jig 14 is inserted into the second wiring 16. The front head portion 14a of the clamp jig 14 passes through the second wiring 16 and is drawn into the body 10. The front head portion 14a then contacts the upper surface of the fixing member 18a. As the operator pushes the fixing member 18a inward, the fixing member 18a is pushed downward and the clamp jig 14 is moved to the interior of the body 10. Consequently, the head portion 14a contacts the contact rod 17c horizontally. As the fixing member 18a is still provided with a force in the vertically upward direction from the solenoid, it travels upward, after temporarily being moved downward, and is inserted into the fixing groove 14b of the clamp jig 14. Once the fixing member 18a is inserted into the fixing groove 14b, it cannot be drawn out by pulling the clamp jig 14, unless it is moved downward and spaced from the fixing groove 14b. As such, the bicycle is bound to an object fixed to the ground by the wire 13 for storage.

When the stored bicycle is to be unlocked, on the other hand, the fixing member 18a is moved downward by simply changing the direction of current flowing through the solenoid, which actuates the fixing member 18a, by a suitable means (e.g., a remote control) to modify the flow of the magnetic field inside the solenoid. As the fixing member 18a is moved downward under the influence of the modified magnetic field, the clamp jig 14 returns to the interior of the first wiring 15 by the pushing force from the spring 17a of the tension mechanism 17 and the action of the main spring 19d connected to the wire drum shaft 11.

The wire 13 is inserted into the clamp jig 14 through a hole formed on the rear surface of the clamp jig 14 and an end of the wire 13 is fixed to the interior of the clamp jig 14 as a fastening member is coupled to a hole separately formed on a lateral surface thereof. Two clamp jigs 14 may be used. In this case, an additional clamp jig 14′ has a hole formed on the front surface thereof so that the wire 13 can pass through.

When two clamp jigs 14 and 14′ are used in this manner, the operator can advantageously cut unnecessary portion of the wire 13 including one clamp jig 14, if he thinks that the wire 13 is too long and is inconvenient to use.

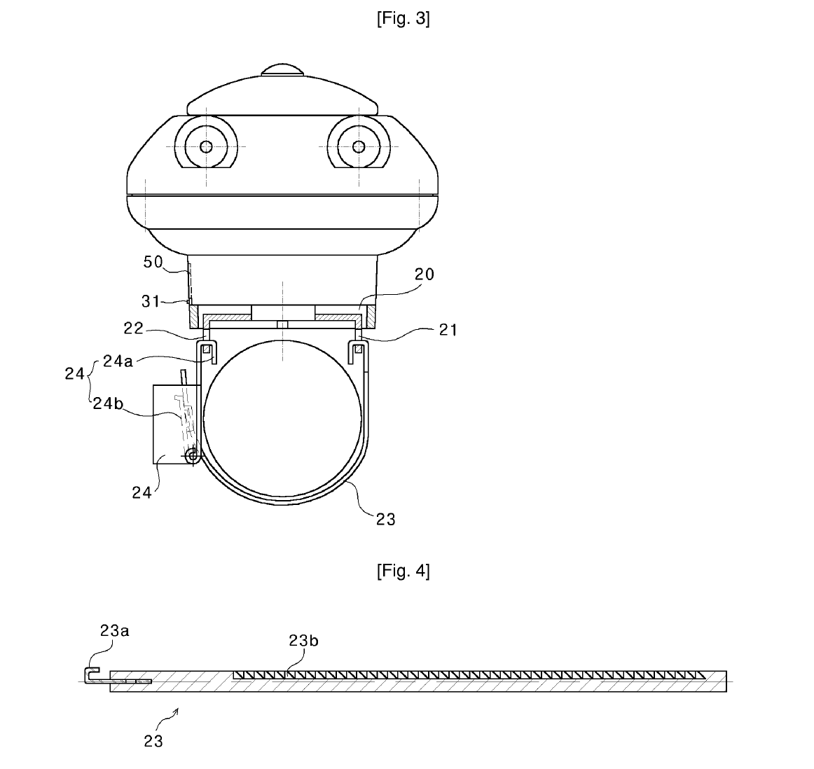

FIG. 3 is a front view showing an burglarproof device for a bicycle according to the present invention, which is installed on a bicycle by a locking means configured as above and an installation means.

Referring to the drawing, the installation means includes a bracket 20, latches 21 and 22, a band 23, and a clasp 24.

The bracket 20 is formed on the bottom surface of the lower cover and may be insert-molded on the lower cover using a metallic material for integral manufacturing. The bracket 20 has first and second latches 21 and 22 formed on a lateral surface thereof. The clasp 24 including a ring portion 24a and a fixing portion 24b is coupled to the second latch 22. The band 23 is coupled to the latches 21 and 22 and the clasp 24 while the bracket 20 is positioned on the upper portion of a bicycle frame to install the inventive burglarproof device on a bicycle.

FIG. 4 shows the band 23 used in the installation means. The band 23 is made of a polyester material with an iron core 23c inserted therein. The band 23 has a ring 23a formed on an end thereof and serrated grooves 23b formed on a surface thereof along the longitudinal direction. An end of the band 23 is fixed as the ring 23a is coupled to the first latch 21 and the opposite end thereof is fixed as the fixing portion 24b of the clasp 24 is inserted into one of the serrated grooves 23b and the ring portion 24a of the clasp 24 engages the second latch 22. This is similar to the case of a commonly used belt wherein the buckle is inserted into one of holes formed on the leather to be fixed. More particularly, the ring 23a can hold nothing but the end of the band 23 while the clasp 24 can hold any part of the band 23 on which a serrated groove 23b is formed. Such a configuration is based on the fact that currently available bicycles have various shapes and standards and the necessary length of the band 23 cannot be determined until the inventive burglarproof device is actually installed on a specific bicycle. Therefore, any redundant part of the band may be cut off as desired after it is held by the clasp 24.

In summary, the inventive installation means is characterized in that a side of the band 23 is held in a fixed position while the other side thereof can be held in a flexible manner. This configuration can be applied and used in various types.

The inventive burglarproof device is provided with an alarming means as described later to generate an alarm when an unauthorized person attempts to steal a stored bicycle.

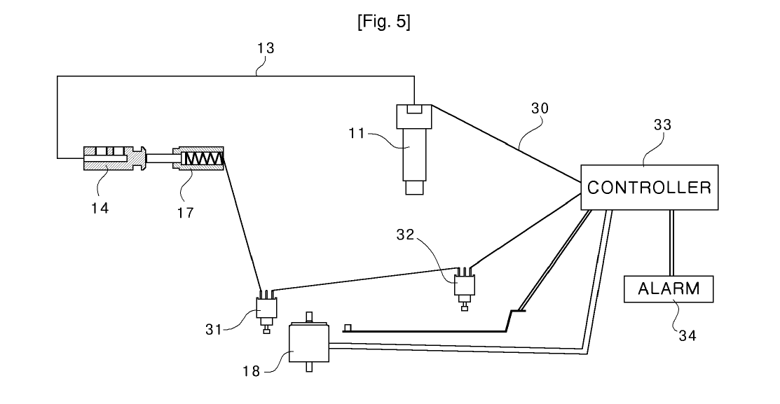

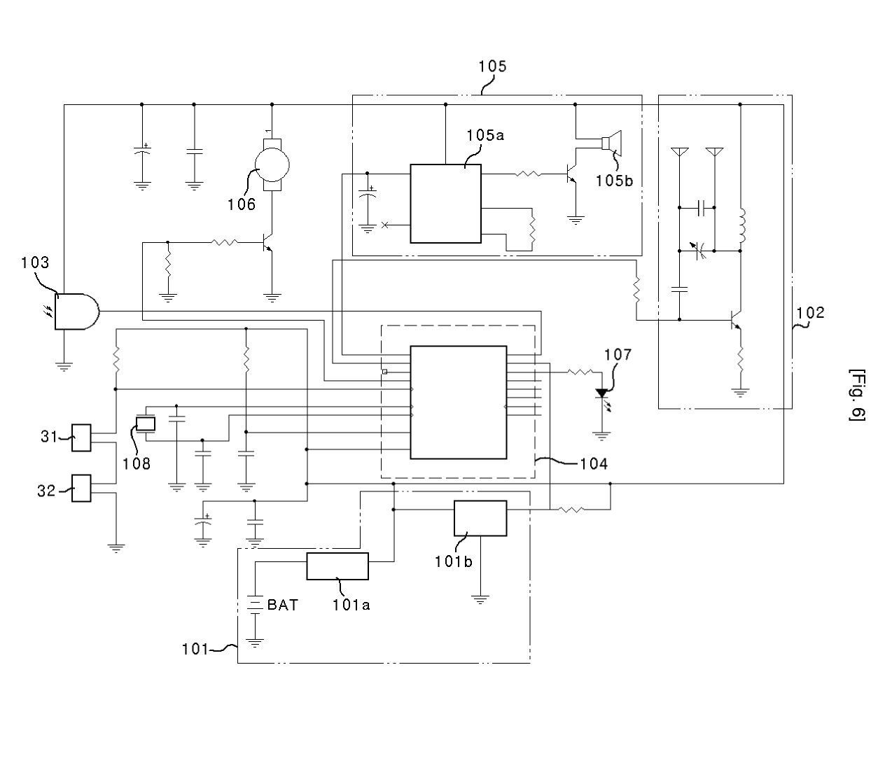

FIG. 5 shows in brief the construction of an alarming means.

Referring to the drawing, the alarming means includes a disconnection detection loop 30, a body separation detection switch 31, a battery cover opening detection switch 32, a controller 33, and an alarm 34.

The disconnection detection loop 30 is connected to the wire drum shaft 11 and the tension mechanism 17, which constitute the locking means. When a bicycle is stored, the wire drum shaft 11 and the tension mechanism 17 are connected to each other by the wire 13 coupled to the clamp jig 14 and the disconnection detection loop 30 establishes a closed loop. When an unauthorized person cuts the wire 13 to steal the bicycle, the disconnection detection loop 30 is disconnected accordingly and fails to maintain the closed loop. As the disconnection of the disconnection detection loop 30 is detected, an alarm is generated to the exterior at the moment of theft. The disconnection detection loop 30 has a controller 33 connected thereto, which has a circuit to detect the disconnection and generate an alarm in the case of disconnection. The controller 33 has an alarm 34 separately connected to the exterior thereof.

The inventive alarming means has a body separation detection switch 31 and a battery cover opening detection switch 32 connected to the disconnection loop 30 in series. This is for the purpose of detecting any attempt of an unauthorized person to, for example, directly separate the body of the locking means from the bicycle frame or remove the battery to interrupt power supplied to the electronic device (e.g., the alarm 34), instead of cutting the wire 13. FIG. 5 shows two switches of a body separation detection switch 31 and a battery cover opening detection switch 32. The body separation detection switch 31 is used to detect an attempt to separate the body 10 from the bicycle frame as shown in FIG. 1 and the battery cover opening detection switch 32 is used to detect an attempt to arbitrarily open the battery cover 50 as shown in FIG. 3. Additional switches may also be used if necessary.

As shown in FIG. 1, the locking means has a replaceable battery 40 inserted into the body 10 thereof to supply power to electronic devices, including the controller 33 and the alarm 34, which constitute the alarming means. Battery terminals 70 contact both ends of the battery 40 to supply power to the controller 33. An LED lamp 80 is installed to give notice to the exterior when the battery 40 is nearly used up and needs to be replaced. A waterproof diaphragm 60 is installed to hermetically isolate the region in which electric devices including the battery 40 and the controller 33 are positioned from the region in which the wire drum 12 is positioned. This is for the purpose of preventing water from spreading into the region in which electric devices are positioned through the groove through which the wire 13 is moved in and out and avoiding current leakage.

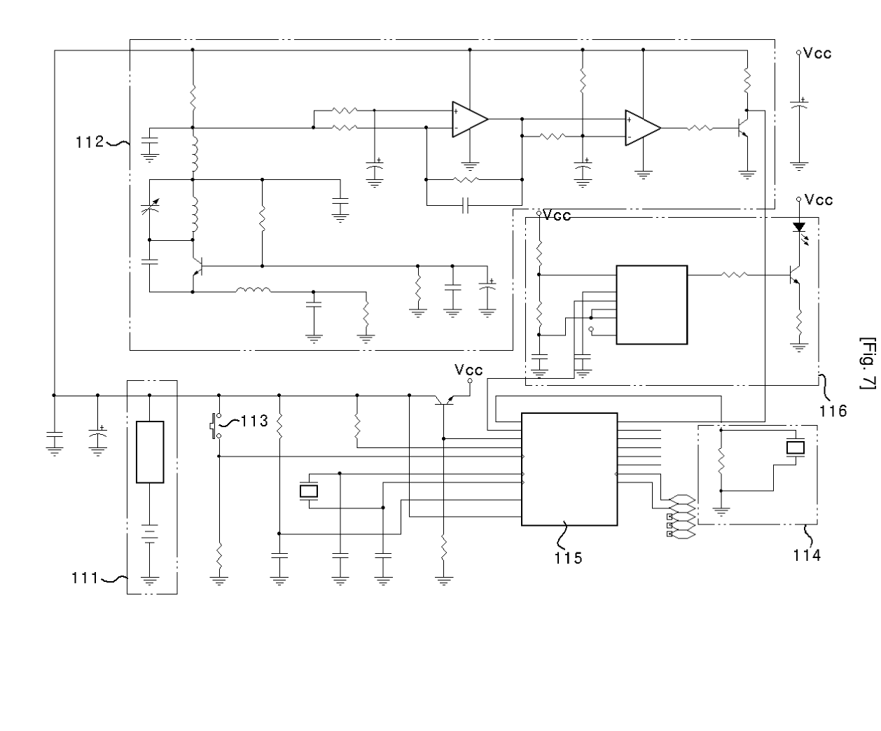

FIG. 6 is a detailed circuit diagram of the alarming means shown in FIG. 5. The controller 33 of the alarming means includes a power supply unit 101, an RF transmitter unit 102, an IR receiver unit 103, a control unit 104, an alarm output unit 105, and a locking device unlocking unit 106.

The power supply unit 101 uses a small battery BAT to supply respective components of the alarming means with necessary power and constant voltage ICs 101a and 101b to convert the voltage of the battery BAT into necessary voltage levels for the respective components.

The RF transmitter unit 102 is adapted to transmit an alarm signal to a remote control alarm positioned in a remote area when an attempt to steal the bicycle is detected, for example when the wire of the alarming means is cut, when the alarming means is separated from the bicycle, or when the battery cover is arbitrarily opened. Although the RF transmitter unit 102 is designed to transmit an alarm signal to a remote control alarm positioned within a distance range of about 200 m, the design may be modified as desired or according to related regulations. The RF transmitter unit 102 may use AM or FM mode for transmission.

The IR receiver 103 is adapted to receive an IR signal from the remote control alarm to unlock the keyed state and input it to the control unit 104.

As mentioned above, the body separation detection switch 31 is actuated when the locking means is mounted on a bicycle and converts the switching state when the locking means, particularly the body is separated from the bicycle to detect the separation of the body. The battery cover opening detection switch 32 is opened when the battery is used up and replaced with a new one. When the remote control alarm is in an alarming mode as described later, however, the battery cover opening detection switch 32 generates an alarm when an unauthorized person arbitrarily opens the battery cover. The operation of the switches 31 and 32 is detected by the control unit 104.

The control unit 104 reads the IR signal from the IR receiver unit 103 and monitors whether the body separation detection switch 31, the battery cover opening detection switch 32, and the wire 13 function normally or not. If an abnormal condition is observed, the control unit 104 controls the alarm output unit 105 to output an alarm sound. The control unit 104 also controls the operation of the locking device unlocking unit 106 to unlock the clamp jig 14. Although the locking device unlocking unit 106 is composed of a solenoid 18 having a fixing member 18a which is movable, a motor may be used as a locking and unlocking means.

The alarm output unit 105 includes an oscillator unit 105a and a buzzer 105b. When a control signal is inputted from the control unit 104, the oscillator unit 105a outputs an oscillation signal to buzz the buzzer 105b. It is obvious to those skilled in the art that, although the alarm output unit 105 is composed of a means for generating an alarm sound, which is an audio signal, it may also have an alarm lamp driving means to drive the alarm lamp together when generating an alarm.

The control unit 104 has an LED connected to an output end thereof as a display unit 107, which is adapted to blink when the user sets the function of the alarming means so that he can be surely informed of the setup status. The display unit 107 uses different blinking cycles to show the function as being selected or deselected.

Reference numeral 108 refers to a crystal oscillator used to generate the primary clock of the control unit 104.

FIG. 7 is a detailed circuit diagram of a remote control alarm which is carried by the user during use and which corresponds to the alarming means shown in FIG. 6.

The remote control alarm corresponding to the alarming means retained on the bicycle is carried by the user to output an alarm signal transmitted from the body and is used as key to unlock the locking device. The remote control alarm includes a power supply unit 111 for supplying power necessary for driving the remote control alarm; an RF receiver unit 112 for receiving and amplifying an RF signal transmitted from the body as an alarm signal; a control unit 115 for identifying the RF signal, checking its own code, comparing the received RF signal with the code for conversion, and actuating an alarm unit 114 to generate an alarm sound when an actuation key 113 is operated to set the remote control alarm in an alarm mode; and an IR transmitter unit 116 for receiving a locking device unlocking signal and an alarm output stop signal, which are encoded and outputted from the control unit 115 by operating the actuation key 113, and converting them into IR signals for transmission.

Signal transmission is performed between the body of the alarming means retained on the bicycle and the remote control alarm by means of code signals mutually corresponding to them, but no mutual communication is performed with the body or the remote control alarm which does not correspond.

The alarming means configured above is operated in such a manner that, when the installation means is dissembled and the body separation detection switch 31 is converted into an off-state, when the battery cover is arbitrarily opened and the battery cover opening detection switch 32 is converted into an off-state, or when the wire 13 is cut and the closed loop is converted into an open loop, the control unit 104 detects the conversion and actuates the alarm output unit 105 to alarm people near the bicycle, as well as transmits an alarm signal loaded with its own code to the remote control alarm via the RF transmitter unit 102 as an RF signal. The control unit 115 of the remote control alarm analyzes the received RF signal and checks the signal transmitted from the alarming means of the body and its own code. The alarm unit 114 is then actuated and generates an alarm.

For example, the alarm sound repeats the cycle of 0.3 second of duration and 0.7 second of pause. The actuation key 113 of the remote control alarm can be operated to stop generating the alarm sound.

When the user operates the remote control alarm, particularly the actuation key 113, to generate an unlocking signal, the control unit 115 controls the IR transmitter unit 116 to convert the unlocking signal loaded with its own code into an IR signal and transmit the signal to the IR receiver 103 of the alarming means of the body. The signal is received by the control unit 104 and compared with its own code. If the received unlocking signal is identified, the solenoid unit 18 acting as the locking device unlocking unit 106 is driven to release the clamp jig 14 acting as the locking device from the tension mechanism 17 and unlock it. The control unit 104 recognizes that the closed loop is converted into an open loop by the unlocking signal from the remote control alarm and does not generate an alarm.

When the actuation key 113 of the remote control alarm is operated in such a manner that the IR transmitter unit 116 transmits an IR signal and the IR receiver unit 103 of the alarming means of the body receives it, the control unit 104 aborts the alarm function if an alarm is being generated and drives the locking device unlocking unit 106 if no alarm is being generated.

### INDUSTRIAL APPLICABILITY

As can be seen from the foregoing, the burglarproof device for a bicycle according to the present invention has a means for binding a bicycle to a nearby fixed facility for storage and transmits an alarm signal to the bicycle owner in a remote area, when an unauthorized person attempts to cut or destroy the means, as well as generates an alarm signal using the means itself for proper action. The inventive apparatus can also be applied to motorcycles or other vehicles as an antitheft means.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. An burglarproof device for a bicycle comprising:
a locking means for fixing a bicycle to an object to prevent it from being stolen;
an installation means for installing the locking means on the frame of the bicycle; and
an alarming means for displaying the locking status of the locking means to the exterior, wherein
the locking means comprises:
a body formed by coupling upper and lower covers to each other with a fastening member;
a wire drum installed at the center of the body and adapted to rotate by means of a wire drum shaft coupled through a hollow;
a wire wound around the wire drum;
a clamp jig having a fixing groove formed along a lateral surface of a front head portion thereof with the wire inserted into and coupled to the rear surface thereof;
a first wiring installed on a side of the outer surface of the upper cover, the front surface of the first wiring being open and the rear surface thereof having a through-hole dimensioned to allow the wire to pass through but not the clamp jig;
a second wiring formed on the other side of the outer surface of the upper cover, both front and rear surfaces of the second wiring being open to allow the clamp jig to pass through;
a tension mechanism installed inside the body to contact the front head portion of the clamp jig, which has passed through the second wiring, horizontally and apply an elastic force to the clamp jig; and
a solenoid unit having a fixing member formed on the upper side thereof, which is adapted to travel vertically under the action of an electronic solenoid to be inserted into or spaced from the fixing groove of the clamp jig.

2. The burglarproof device for a bicycle according to claim 1, wherein the installation means comprises:
a bracket formed on the lower surface of the lower cover;
first and second latches formed on the lateral surfaces of the bracket, respectively;
a band having serrated grooves formed on a surface thereof along a longitudinal direction and a ring formed on an end thereof to engage the first latch; and
a clasp having a fixing portion to be inserted into one of the grooves of the band and a ring portion to engage the second latch so that the other end of the band and the second latch can be coupled to each other.

3. The burglarproof device for a bicycle according to claim 2, wherein the band is made of a polyester material having an iron core inserted therein.

4. The burglarproof device for a bicycle according to claim 1, wherein the alarming means comprises:
a disconnection detection loop installed inside the body with a side connected to the wire drum shaft and the other side connected to the tension mechanism;
a controller connected to the disconnection detection loop and provided with a means to generate an alarm when disconnection is detected; and
an alarm separately connected to the controller to generate an alarm to the exterior.

5. The burglarproof device for a bicycle according to claim 4, wherein the disconnection detection loop has at least one switch connected thereto in series, which is chosen from a group comprising a body separation detection switch for detecting the separation of the body of the locking means from the frame of the bicycle and a battery cover opening detection switch for detecting the opening of a battery cover.

6. The burglarproof device for a bicycle according to claim 4, wherein the controller has an RF transmitter unit for encoding an alarm signal into an RF signal and transmitting it to a remote control alarm in a remote area and an IR receiver unit for receiving a signal to deselect a locking function or alarming function from the remote control alarm and the remote control alarm has an RF receiver unit for receiving the RF signal, a control unit for analyzing the RF signal received by the RF receiver unit, checking a signal transmitted from the alarming means of the body and its own code, and actuating an alarm unit to generate an alarm, and an IR transmitter unit for encoding a signal to deselect a locking function or alarming function based on the operation of an operation key and converting it into an IR signal and outputting it.

7. The burglarproof device for a bicycle according to claim 6, wherein the RF signal is a signal modulated in an AM or FM mode.
